(19) United States
(12) Patent Application Publication
(10) Pub. No.: US 2026/0368032 A1
(43) Pub. Date: Nov. 19, 2026

(54) MACHINE LEARNING BASED MIN-SUM HARD DECODING WITH NAND ASSISTED READS

(71) Applicant: SK hynix Inc., Gyeonggi-do (KR)

(72) Inventors: Pengfei HUANG, San Jose, CA (US); Fan ZHANG, San Jose, CA (US); Hongwei DUAN, San Jose, CA (US)

(21) Appl. No.: 19/209,730

(22) Filed: May 15, 2025

(51) Int. Cl. G06F 11/10

(52) U.S. Cl. CPC G06F 11/1016; G06F 11/1048; G06F 11/1068

(57) ABSTRACT

A memory system, and method for operating the same, which performs page reads on multi-level cells (MLCs) using different read biases; performs one or more NAND-assist reads of the MLCs at one or more single level cell biases between the different read biases; generates, from the page reads and the NAND-assist reads, cell pattern data and log likelihood ratio (LLR) information for the cell pattern data; decodes the page read data using the LLR information for the cell pattern data; and when errors are present in the decoded data, adjusts the LLR based on machine learned asymmetry ratio information of the cell pattern data for subsequent decoding.

### BACKGROUND

### 1. Field

Embodiments of the present disclosure relate to a scheme for a read operation of a memory system.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices. Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

Memory systems can perform operations such as read and decoding operations on data stored therein. In this context, embodiments of the present invention arise.

### SUMMARY

In one aspect, there is provided a memory system comprising a memory device including a NAND device having multi-level cells (MLCs) with pages of data stored therein; and a controller coupled to the NAND device, and configured to: perform page reads on the MLCs using different read biases; perform one or more NAND-assist reads of the MLCs at one or more single level cell biases between the different read biases; generate, from the page reads and the NAND-assist reads, cell pattern data and log likelihood ratio (LLR) information for the cell pattern data; decode the page read data using the LLR information for the cell pattern data; and when errors are present in the decoded data, adjust the LLR based on machine learned asymmetry ratio information of the cell pattern data for subsequent decoding.

In another aspect, there is provided a method for operating a memory system including a NAND device having multi-level cells (MLCs) with pages of data stored therein. The method includes performing page reads on the MLCs using different read biases; performing one or more NAND-assist reads of the MLCs at one or more single level cell biases between the different read biases; generating, from the page reads and the NAND-assist reads, cell pattern data and log likelihood ratio (LLR) information for the cell pattern data; decoding the page read data using the LLR information for the cell pattern data; and when errors are present in the decoded data, adjusting the LLR based on machine learned asymmetry ratio information of the cell pattern data for subsequent decoding.

Additional aspects of the present invention will become apparent from the following description.

### BRIEF DESCRIPTION OF THE DRAWINGS

FIG. 1 is a block diagram illustrating a data processing system.

FIG. 2 is a block diagram illustrating a memory system.

FIG. 3 is a circuit diagram illustrating a memory block of a memory device.

FIG. 4 is a diagram illustrating distributions of states for different types of cells of a memory device.

FIG. 5A is a diagram illustrating an example of Gray coding for a multi-level cell (MLC).

FIG. 5B is a diagram illustrating state distributions for pages of a multi-level cell (MLC).

FIG. 6A is a diagram illustrating one example of Gray coding for a triple-level cell (TLC).

FIG. 6B is a diagram illustrating state distributions for pages of a triple-level cell (TLC).

FIG. 7 is a diagram illustrating one example of Gray coding and state distributions for pages of a quadruple-level cell (QLC).

FIG. 8 is a diagram illustrating a flow of an error recovery algorithm in a memory system.

FIG. 9 is a diagram illustrating a memory system in accordance with one embodiment of the present invention.

FIG. 10 is a diagram illustrating a format of a codeword to be stored in a storage system in accordance with embodiments of the present invention.

FIG. 11 is a table illustrating Gray labelling for a TLC NAND in accordance with one embodiment of the invention.

FIG. 12 is a diagram illustrating a TLC LSB page read and one SLC assist read in accordance with one embodiment of the invention.

FIG. 13 is a diagram illustrating a TLC MSB page read and one SLC assist read in accordance with one embodiment of the invention.

FIG. 14 is a diagram illustrating a TLC CSB page read and two SLC assist reads in accordance with one embodiment of the invention.

FIG. 15 is a diagram illustrating machine learning based min-sum hard decoding with NAND assist reads in accordance with one embodiment of the invention.

FIG. 16 is a diagram illustrating is a flowchart illustrating an operation of a memory device according to one embodiment of the invention.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, for example including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general device or circuit component that is configured or otherwise programmed to perform the task at a given time or as a specific device or as a circuit component that is manufactured or pre-configured or pre-programmed to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed for example by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described herein, the code or instructions for implementing the operations of the method embodiments may transform the computer, processor, controller, or other signal processing device into a special-purpose processor for performing any one of the methods herein.

If implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of various embodiments of the present invention is provided below along with accompanying figures that illustrate aspects of the present invention. The present invention is described in connection with such embodiments, but the present invention is not limited to any specific embodiment. The present invention encompasses numerous alternatives, modifications and equivalents. Numerous specific details are set forth in the following description in order to provide a thorough understanding of the present invention. These details are provided for the purpose of example; the present invention may be practiced without some or all of these specific details. For clarity, technical material that is known in technical fields related to the present invention has not been described in detail so that the invention is not unnecessarily obscured.

Semiconductor memory devices may be volatile or nonvolatile. The volatile semiconductor memory devices perform read and write operations at high speeds, while contents stored therein may be lost at power-off. The nonvolatile semiconductor memory devices may retain contents stored therein even at power-off. The nonvolatile semiconductor memory devices may be used to store contents, which must be retained regardless of whether they are powered.

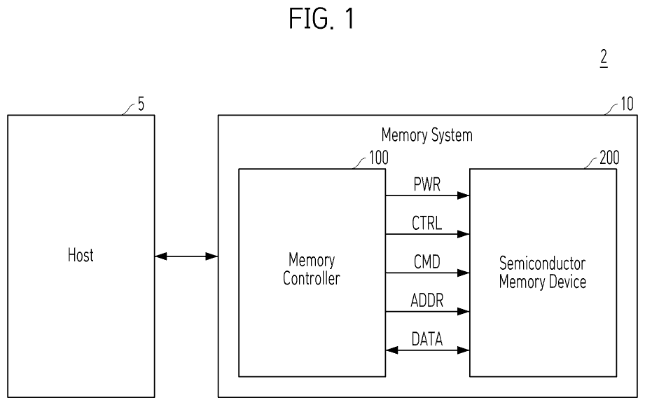

FIG. 1 is a block diagram illustrating a data processing system 2 in accordance with one embodiment of the present invention.

Referring FIG. 1, the data processing system 2 may include a host device 5 and a memory system 10. The memory system 10 may receive a request from the host device 5 and operate in response to the received request. For example, the memory system 10 may store data to be accessed by the host device 5.

The host device 5 may be implemented with any of various types of electronic devices. In various embodiments, the host device 5 may be an electronic device such as for example a desktop computer, a workstation, a three-dimensional (3D) television, a smart television, a digital audio recorder, a digital audio player, a digital picture recorder, a digital picture player, and/or a digital video recorder and a digital video player. In various embodiments, the host device 5 may be a portable electronic device such as for example a mobile phone, a smart phone, an e-book, an MP3 player, a portable multimedia player (PMP), and/or a portable game player.

The memory system 10 may be implemented with any of various types of storage devices such as a solid state drive (SSD) and a memory card. In various embodiments, the memory system 10 may be provided as one of various components in an electronic device such as for example a computer, an ultra-mobile personal computer (PC) (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, a radio-frequency identification (RFID) device, as well as one of various electronic devices of a home network, one of various electronic devices of a computer network, one of electronic devices of a telematics network, or one of various components of a computing system.

The memory system 10 may include a memory controller 100 and a semiconductor memory device 200. The memory controller 100 may control overall operations of the semiconductor memory device 200 including those of bit error rate reporting as detailed below.

The semiconductor memory device 200 may perform one or more erase, program, and read operations under the control of the memory controller 100. The semiconductor memory device 200 may receive through input/output lines a command CMD, an address ADDR and data DATA. The semiconductor memory device 200 may receive power PWR through a power line and a control signal CTRL through a control line. The control signal CTRL may include for example a command latch enable signal, an address latch enable signal, a chip enable signal, a write enable signal, a read enable signal, as well as other operational signals depending on design and configuration of the memory system 10.

The memory controller 100 and the semiconductor memory device 200 may be integrated in a single semiconductor device such as a solid state drive (SSD). The SSD may include a storage device for storing data therein.

The memory controller 100 and the semiconductor memory device 200 may be integrated in a single semiconductor device such as a memory card. For example, the memory controller 100 and the semiconductor memory device 200 may be integrated to configure a personal computer (PC) card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), and/or a universal flash storage (UFS).

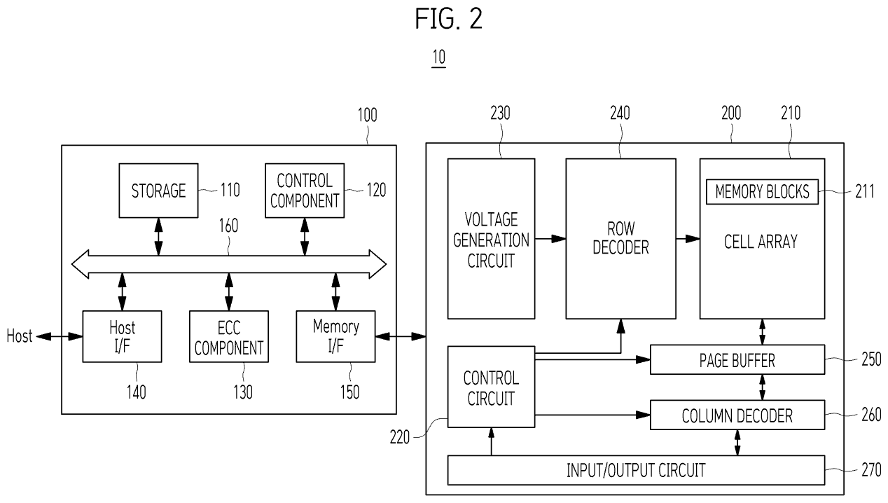

FIG. 2 is a block diagram illustrating a memory system in accordance with one embodiment of the present invention. For example, the memory system of FIG. 2 may depict the memory system 10 shown in FIG. 1.

Referring to FIG. 2, the memory system 10 may include a memory controller 100 and a semiconductor memory device 200. The memory system 10 may operate in response to a request from a host device (e.g., a request from host device 5 of FIG. 1), and in particular, store data to be accessed by the host device.

The memory device 200 may store data to be accessed by the host device.

The memory device 200 may be implemented with a volatile memory device such as for example a dynamic random access memory (DRAM) and/or a static random access memory (SRAM) or a non-volatile memory device such as for example a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), and/or a resistive RAM (RRAM).

The controller 100 may control storage of data in the memory device 200. For example, the controller 100 may control the memory device 200 in response to a request from the host device. The controller 100 may provide data read from the memory device 200 to the host device, and may store data provided from the host device into the memory device 200.

The controller 100 may include a storage 110, a control component 120, which may be implemented as a processor such as for example a central processing unit (CPU), an error correction code (ECC) component 130, a host interface (I/F) 140 and a memory interface (I/F) 150, which are coupled through a bus 160.

The storage 110 may serve as a working memory of the memory system 10 and the controller 100, and storage 110 may store data for driving the memory system 10 and the controller 100 The storage 110 may store data for encoding and/or decoding the data bit information being transmitted/received. For example, when the controller 100 controls operations of the memory device 200, the storage 110 may store data used by the controller 100 and the memory device 200 for such operations as read, write, program and erase operations, including encoding and decoding.

The storage 110 may be implemented with a volatile memory such as a static random access memory (SRAM) or a dynamic random access memory (DRAM). As described above, the storage 110 may store data used by the host device in the memory device 200 for the read and write operations. To store the data, the storage 110 may include a program memory, a data memory, a write buffer, a read buffer, a map buffer, and the like.

The control component 120 may control general operations of the memory system 10, and a write operation or a read operation for the memory device 200, in response to a write request or a read request from the host device. The control component 120 may drive firmware or other program instructions, which can be referred to as a flash translation layer (FTL), to control operations of the memory system 10. For example, the FTL may perform operations such as logical-to-physical (L2P) mapping, wear leveling, garbage collection, and/or bad block handling. The L2P mapping is known as logical block addressing (LBA).

The ECC component 130 may detect and correct errors in the data read from the memory device 200 during the read operation as detailed below. In one embodiment, the ECC component 130 may not correct error bits when the number of the error bits is greater than or equal to a threshold number of correctable error bits, but instead may output an error correction fail signal indicating failure in correcting the error bits.

In various embodiments, the ECC component 130 may perform an error correction operation based on a coded modulation such as for example a low density parity check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), or a Block coded modulation (BCM). As such, the ECC component 130 may include any and all circuits, systems or devices suitable for error correction operation. In one embodiment of the present invention, a quasi-cyclic LDPC matrix is used for data recovery and bit error reporting.

The host interface 140 may communicate with the host device through one or more of various communication standards or interfaces such as for example a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), and an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the control component 120. In one embodiment where the memory device 200 is a flash memory such as a NAND flash memory, the memory interface 150 may generate control signals for the memory and process data under the control of the control component 120.

The memory device 200 as shown for example in FIG. 2 may include a memory cell array 210, a control circuit 220, a voltage generation circuit 230, a row decoder 240, a page buffer 250, which may be in the form of an array of page buffers, a column decoder 260, and an input and output (input/output) circuit 270. The memory cell array 210 may include a plurality of memory blocks 211 which may store data. The voltage generation circuit 230, the row decoder 240, the page buffer array 250, the column decoder 260 and the input/output circuit 270 may form a peripheral circuit for the memory cell array 210. The peripheral circuit may perform program, read, or erase operations of the memory cell array 210. The control circuit 220 may control the peripheral circuit.

The voltage generation circuit 230 may generate operational voltages of various levels. For example, in an erase operation, the voltage generation circuit 230 may generate operational voltages of various levels such as for example an erase voltage and a pass voltage.

The row decoder 240 may be in electrical communication with the voltage generation circuit 230, and the plurality of memory blocks 211. The row decoder 240 may select at least one memory block among the plurality of memory blocks 211 in response to a row address generated by the control circuit 220, and transmit operation voltages supplied from the voltage generation circuit 230 to the selected memory blocks.

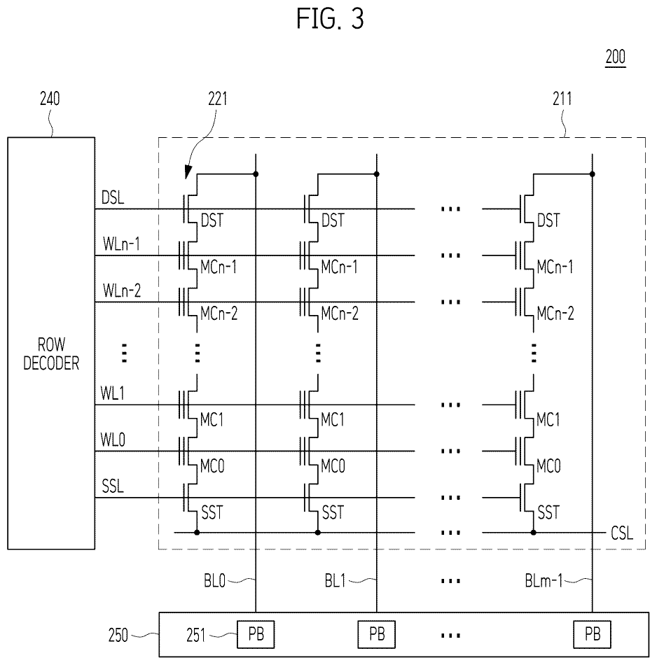

The page buffer 250 may be coupled with the memory cell array 210 through bit lines BL (shown in FIG. 3). The page buffer 250 may precharge the bit lines BL with a positive voltage, transmit data to, and receive data from, a selected memory block in program and read operations, or temporarily store transmitted data, in response to page buffer control signal(s) generated by the control circuit 220.

The column decoder 260 may transmit data to, and receive data from, the page buffer 250 or may transmit and receive data to and from the input/output circuit 270.

The input/output circuit 270 may transmit to the control circuit 220 a command and an address, received from an external device (e.g., the memory controller 100 of FIG. 1), transmit data from the external device to the column decoder 260, or output data from the column decoder 260 to the external device.

The control circuit 220 may control the peripheral circuit in response to the command and the address.

FIG. 3 is a circuit diagram illustrating a memory block of a semiconductor memory device in accordance with one embodiment of the present invention. For example, the memory block of FIG. 3 may be any of the memory blocks 211 of the memory cell array 210 shown in FIG. 2.

Referring to FIG. 3, the memory block 211 may include a plurality of word lines WL0 to WLn-1, a drain select line DSL and a source select line SSL coupled to the row decoder 240. These lines may be arranged in parallel, with the plurality of word lines between the DSL and SSL.

The memory block 211 may further include a plurality of cell strings 221 respectively coupled to bit lines BL0 to BLm-1. The cell string of each column may include one or more drain selection transistors DST and one or more source selection transistors SST. In the illustrated embodiment, each cell string has one DST and one SST. In a cell string, a plurality of memory cells or memory cell transistors MC0 to MCn-1 may be serially coupled between the selection transistors DST and SST. Each of the memory cells may be formed as a multiple level cell. For example, each of the memory cells may be formed as a single level cell (SLC) storing 1 bit of data. Each of the memory cells may be formed as a multi-level cell (MLC) storing 2 bits of data. Each of the memory cells may be formed as a triple-level cell (TLC) storing 3 bits of data. Each of the memory cells may be formed as a quadruple-level cell (QLC) storing 4 bits of data.

The source of the SST in each cell string may be coupled to a common source line CSL, and the drain of each DST may be coupled to the corresponding bit line. Gates of the SSTs in the cell strings may be coupled to the SSL, and gates of the DSTs in the cell strings may be coupled to the DSL. Gates of the memory cells across the cell strings may be coupled to respective word lines. That is, the gates of memory cells MC0 are coupled to corresponding word line WL0, the gates of memory cells MC1 are coupled to corresponding word line WL1, etc. The group of memory cells coupled to a particular word line may be referred to as a physical page. Therefore, the number of physical pages in the memory block 211 may correspond to the number of word lines.

The page buffer array 250 may include a plurality of page buffers 251 that are coupled to the bit lines BL0 to BLm-1. The page buffers 251 may operate in response to page buffer control signals. For example, the page buffers 251 my temporarily store data received through the bit lines BL0 to BLm-1 or sense voltages or currents of the bit lines during a read or verify operation.

In various embodiments of the present invention, the memory blocks 211 may include a NAND-type flash memory cell. However, the memory blocks 211 are not limited to such cell type, and may include NOR-type flash memory cell(s). Memory cell array 210 may be implemented as a hybrid flash memory in which two or more types of memory cells are combined, or one-NAND flash memory in which a controller is embedded inside a memory chip.

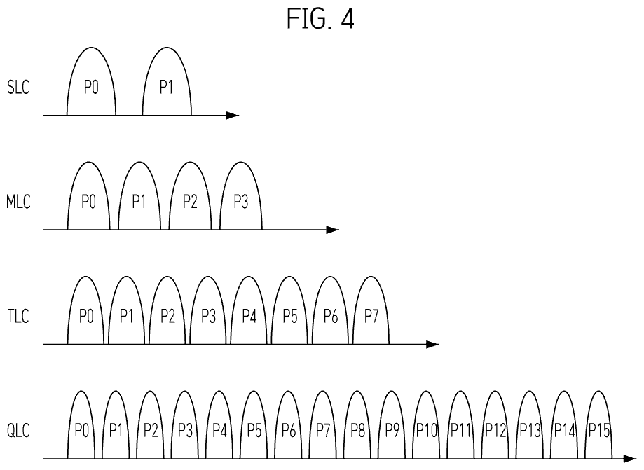

FIG. 4 is a diagram illustrating distributions of states or program voltage (PV) levels for different types of cells of a memory device.

Referring to FIG. 4, each of memory cells may be implemented with a specific type of cell, for example, a single level cell (SLC) storing 1 bit of data, a multi-level cell (MLC) storing 2 bits of data, a triple-level cell (TLC) storing 3 bits of data, or a quadruple-level cell (QLC) storing 4 bits of data. Usually, all memory cells in a particular memory device are of the same type, but that is not a requirement.

An SLC may include two states P0 and P1. P0 may indicate an erase state, and P1 may indicate a program state. Since the SLC can be set in one of two different states, each SLC may program or store 1 bit according to a set coding method. An MLC may include four states P0, P1, P2 and P3. Among these states, P0 may indicate an erase state, and P1 to P3 may indicate program states. Since the MLC can be set in one of four different states, each MLC may program or store two bits according to a set coding method. A TLC may include eight states P0 to P7. Among these states, P0 may indicate an erase state, and P1 to P7 may indicate program states. Since the TLC can be set in one of eight different states, each TLC may program or store three bits according to a set coding method. A QLC may include 16 states P0 to P15. Among these states, P0 may indicate an erase state, and P1 to P15 may indicate program states. Since the QLC can be set in one of sixteen different states, each QLC may program or store four bits according to a set coding method.

Referring back to FIGS. 2 and 3, the memory device 200 may include a plurality of memory cells (e.g., NAND flash memory cells). The memory cells are arranged in an array of rows and columns as shown in FIG. 3. The cells in each row are connected to a word line (e.g., WL0), while the cells in each column are coupled to a bit line (e.g., BL0). These word and bit lines are used for read and write operations. During a write operation, the data to be written (‘1’ or ‘0’) is provided at the bit line while the word line is addressed. During a read operation, the word line is again addressed, and the threshold voltage of each cell can then be acquired from the bit line. Multiple pages may share the memory cells that belong to (i.e., are coupled to) the same word line. When the memory cells are implemented with MLCs, the multiple pages include a most significant bit (MSB) page and a least significant bit (LSB) page. When the memory cells are implemented with TLCs, the multiple pages include an MSB page, a center significant bit (CSB) page and an LSB page. When the memory cells are implemented with QLCs, the multiple pages include an upper significant bit (USB) page, an MSB page, a CSB page and an LSB page. The memory cells may be programmed for example using a coding scheme (e.g., Gray coding) in order to increase the capacity of the memory system 10 such as SSD.

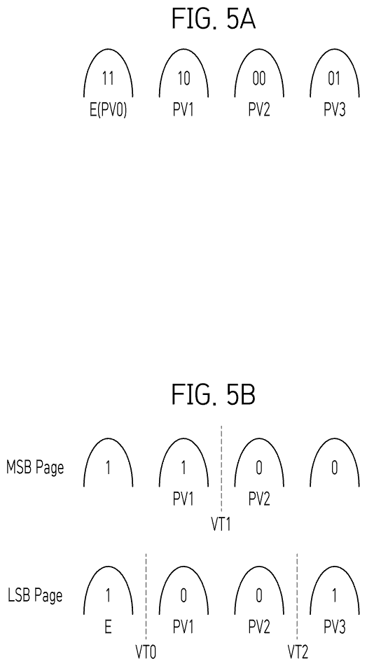

FIG. 5A is a diagram illustrating an example of coding for a multi-level cell (MLC).

Referring to FIG. 5A, an MLC may be programmed using a set type of coding. An MLC may have 4 program states, which include an erased state E (or PV0) and a first program state P1 to a third program state P3. The erased state E (or PV0) may correspond to “11.” The first program state P1 may correspond to “10.” The second program state P2 may correspond to “00.” The third program state P3 may correspond to “01.”

In the MLC, as shown in FIG. 5B, there are 2 types of pages including LSB and MSB pages. 1 or 2 thresholds may be applied in order to retrieve data from the MLC. For an MSB page, the single threshold value is VT1. VT1 distinguishes between the first program state PV1 and the second program state PV2. For an LSB page, 2 thresholds include a threshold value VT0 and a threshold value VT2. VT0 distinguishes between the erased state E and the first program state PV1. V2 distinguishes between the second program state PV2 and the third program state PV3.

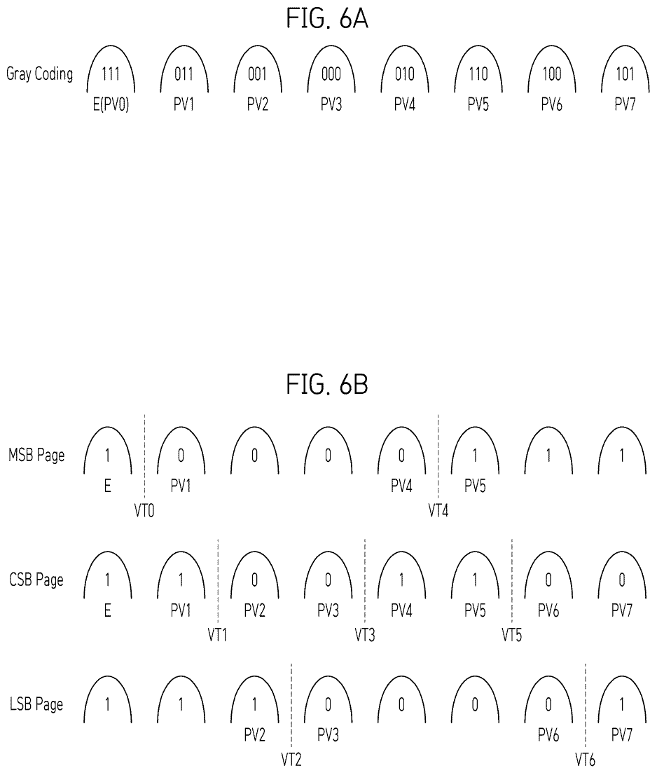

FIG. 6A is a diagram illustrating an example of Gray coding for a triple-level cell (TLC). FIG. 6B is a diagram illustrating state distributions for pages of a triple-level cell (TLC).

Referring to FIG. 6A, a TLC may be programmed using Gray coding. A TLC may have 8 program states, which include an erased state E (or PV0) and a first program state PV1 to a seventh program state PV7. The erased state E (or PV0) may correspond to “111.” The first program state PV1 may correspond to “011.” The second program state PV2 may correspond to “001.” The third program state PV3 may correspond to “000.” The fourth program state PV4 may correspond to “010.” The fifth program state PV5 may correspond to “110.” The sixth program state PV6 may correspond to “100.” The seventh program state PV7 may correspond to “101.”

In the TLC, as shown in FIG. 6B, there are 3 types of pages including LSB, CSB and MSB pages. 2 or 3 thresholds may be applied in order to retrieve data from the TLC. For an MSB page, 2 thresholds include a threshold value VT0 that distinguishes between an erased state E and a first program state PV1 and a threshold value VT4 that distinguishes between a fourth program state PV4 and a fifth program state PV5. For a CSB page, 3 thresholds include VT1, VT3 and VT5. VT1 distinguishes between a first program state PV1 and a second program state PV2. VT3 distinguishes between a third program state PV3 and the fourth program state PV4. VT5 distinguishes between the fourth program state PV5 and the sixth program state PV6. For an LSB page, 2 thresholds include VT2 and VT6. VT2 distinguishes between the second program state PV2 and the third program state PV3. VT6 distinguishes between the sixth program state PV6 and a seventh program state PV7.

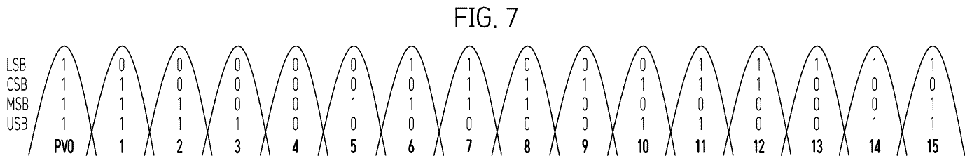

FIG. 7 is a diagram illustrating one example of Gray coding and state distributions for pages of a quadruple-level cell (QLC).

Referring to FIG. 7, a QLC may be programmed using Gray coding. A QLC may have 16 program states, which include an erased state PV0 (or E) and a first program state PV1 to a 15th program state PV15. The erased state PV0 may correspond to “1111.” The first program state PV1 may correspond to “0111.” The second program state PV2 may correspond to “0011.” The third program state PV3 may correspond to “0001.” The fourth program state PV4 may correspond to “0000.” The fifth program state PV5 may correspond to “0010.” The sixth program state PV6 may correspond to “1010.” The seventh program state PV7 may correspond to “1110.” The eighth program state PV8 may correspond to “0110.” The ninth program state PV9 may correspond to “0100.” The tenth program state PV10 may correspond to “0101.” The 11th program state PV11 may correspond to “1101.” The 12th program state PV12 may correspond to “1100.” The 13th program state PV13 may correspond to “1000.” The 14th program state PV14 may correspond to “1001.” The 15th program state PV15 may correspond to “1011.”

In the QLC, as shown in FIG. 7, there are 4 types of pages including LSB, CSB, MSB and USB pages. 3 or 4 thresholds may be applied in order to retrieve data from the QLC. For an USB page, 4 thresholds include a threshold value that distinguishes between a program state PV3 and a program state PV4, a threshold value that distinguishes between a program state PV9 and a program state PV10, a threshold value that distinguishes between a program state PV11 and a program state PV12, and a threshold value that distinguishes between a program state PV13 and a program state PV14. For an MSB page, 4 thresholds include a threshold value that distinguishes between a program state PV2 and a program state PV3, a threshold value that distinguishes between a program state PV4 and a program state PV5, a threshold value that distinguishes between a program state PV8 and a program state PV9, and a threshold value that distinguishes between a program state PV14 and a program state PV15. For a CSB page, 3 thresholds include a threshold value that distinguishes between a program state PV1 and a program state PV2, a threshold value that distinguishes between a program state PV6 and a program state PV7, and a threshold value that distinguishes between a program state PV12 and a program state PV13. For an LSB page, 4 thresholds include a threshold value that distinguishes between an erased state PV0 and a program state PV1, a threshold value that distinguishes between a program state PV5 and a program state PV6, a threshold value that distinguishes between a program state PV7 and a program state PV8, and a threshold value that distinguishes between a program state PV10 and a program state PV11.

After a memory array including a plurality of memory cells is programmed as described in FIGS. 5A, 6A and 7, when a read operation is performed on the memory array using a reference voltage such as a read threshold voltage (also called “read voltage level” or “read threshold”), the electrical charge levels of the memory cells (e.g., threshold voltage levels of transistors of the memory cells) are compared to one or more reference voltages to determine the state of individual memory cells. When a specific read threshold is applied to the memory array, those memory cells that have threshold voltage levels higher than the reference voltage are turned on and detected as “on” cell, whereas those memory cells that have threshold voltage levels lower than the reference voltage are turned off and detected as “off” cell, for example. Therefore, each read threshold is arranged between neighboring threshold voltage distribution windows corresponding to different programmed states so that each read threshold can distinguish such programmed states by turning on or off the memory cell transistors.

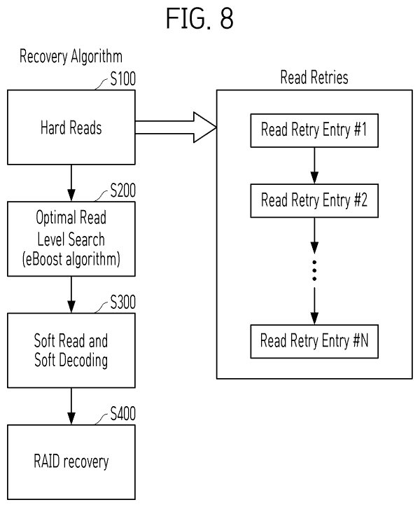

When a read operation is performed on memory cells in a data storage device, the threshold voltage levels of the memory cells are compared to more than one read threshold level to determine the state of individual memory cells. Read errors can be caused by distorted or overlapped threshold voltage distributions. An ideal memory cell threshold voltage distribution can change over time to be distorted or overlapped due to, e.g., program and erase (P/E) cycles, cell-to-cell interference, and/or data retention errors. For example, as program/erase cycles increase, the margin between neighboring threshold voltage distributions of different programmed states decreases and eventually the distributions overlap. As a result, the memory cells with threshold voltages that fall within the overlapping region of the neighboring distributions may be read as being programmed to a value other than the original targeted value and thus cause read errors. Such read errors may be managed in many situations by using error correction codes (ECC). When the number of bit errors on a read operation exceeds the ECC correction capability of the data storage, the read operation using a set read threshold voltage fails. The set read threshold voltage may be a previously used read threshold voltage (i.e., a historical read threshold voltage). The historical read threshold voltage may be the read threshold voltage used in the last successful decoding, that is, a read voltage used in a read-passed read operation performed before read retry operations. When the read operation using the set read threshold voltage failed, the controller 120 may control an error recovery algorithm such as for example the algorithm shown in FIG. 8.

Referring to FIG. 8, a controller (such as control component 120 in FIG. 2) may perform a sequence of hard reads to read data of a page (i.e., memory cells) using one or more hard read entries applied in a set order (S100). For example, the hard read entries may include N (e.g., N is 5 or 10) read threshold voltages (or read voltage levels) including a first read threshold voltage to an Nth read threshold voltage. The first read threshold voltage may be a previously used read threshold voltage (i.e., a history (historical) read threshold voltage). The historical read threshold voltage may be the read threshold voltage used in the last successful decoding, that is, a read voltage used in a read-passed read operation performed before the read retry operations. The controller 120 may perform the read retry operations until it is determined that decoding associated with a corresponding read retry operation is successful.

When all hard read retry operations using the N read threshold voltages have failed, the controller 120 may perform additional recovery operations. For example, the additional recovery operations may include an optimal read threshold voltage search (S200), a soft read and soft decoding using an error correction code (ECC) (S300) and/or a redundant array of independent disks (RAID) recovery (S400).

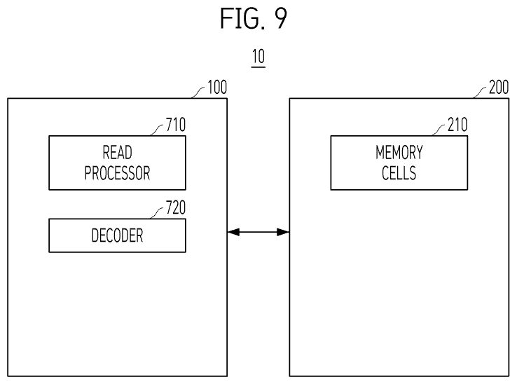

FIG. 9 is a diagram illustrating a memory system 10 in accordance with one embodiment of the present invention.

Referring to FIG. 9, the memory system 10 may include a controller 100 and a memory device 200. The memory device 200 may include a plurality of memory cells (e.g., NAND flash memory cells) 210. The memory cells are arranged in an array of rows and columns such as shown in FIG. 3. The cells in each row are connected to a word line (e.g., WL0), while the cells in each column are coupled to a bit line (e.g., BL0). These word and bit lines are used for read and write operations. During a write operation, the data to be written (‘1’ or ‘0’) is provided at the bit line while the word line is addressed. During a read operation, the word line is again addressed, and the threshold voltage of each cell can then be acquired from the bit line. Multiple pages may share the memory cells that belong to (i.e., are coupled to) the same word line. When the memory cells are implemented with MLCs, the multiple pages include a most significant bit (MSB) page and a least significant bit (LSB) page. When the memory cells are implemented with TLCs, the multiple pages include an MSB page, a center significant bit (CSB) page and an LSB page. When the memory cells are implemented with QLCs, the multiple pages include an USB page, an MSB page, a CSB page and an LSB page. The memory cells may be programmed using a coding scheme (e.g., Gray coding) in order to increase the capacity of the memory system 10 such as an SSD.

During a program operation of Multi-Level NAND, memory cells are typically programmed into one of 2N possible threshold voltages to store N bits of information. For example, the initial state of the Multi-Level NAND may be the state in which a program operation has not been performed and in which the threshold voltages of the memory cells are all in the erase state E (zero voltage). Following programming, each of the memory cells may have a threshold voltage corresponding to one of a plurality of program states of the Multi-Level NAND. Each of the memory cells on which the program operation has been performed may have a threshold voltage corresponding to one of the erase state E (PV0) and (in the case of a TLC) the first to seventh program states PV1 to PV7, as shown in FIG. 6A. The threshold voltage can be achieved by applying a series of program pulses P (N, N+1, . . . ) with increasing bias magnitude to a control gate of targeted NAND cells. Each program pulse is followed by a series of verify PV pulses to compare the threshold voltage of the targeted NAND cells against a specific program verify level.

The controller 100 may include a read processor 710 and a decoder 720. Although it is illustrated that components of the controller 100 are implemented separately, these components may be implemented with an internal component (i.e., firmware (FW)) of the control component 120 in FIG. 2. The controller 100 and the memory device 200 may include various other components such as those shown in FIG. 2. Further, the controller 100 may include a media management processor 730 which is described later.

The read processor 710 may control one or more read operations for the memory device 200 in response to a read request from a host (e.g., the host 5 of FIG. 1). The read processor 710 may control the read operations using various read thresholds. The decoder 720 may decode data associated with the read operations.

In various embodiments of the present invention, the read processor 710 may control a read operation for the memory cells using a select read threshold from a set read level table. In various embodiments, the read level table may include multiple read thresholds and the select read threshold may include a default read threshold as described with reference to FIGS. 5B, 6B and 7.

In one embodiment of the present invention, it is determined whether the read operation using a read threshold selected from a read threshold set succeeded or failed, depending on the decoding result of the decoder 720. When the read operation using the selected read threshold failed, the read processor 710 may control one or more read retry operations for the memory cells using read retry entries.

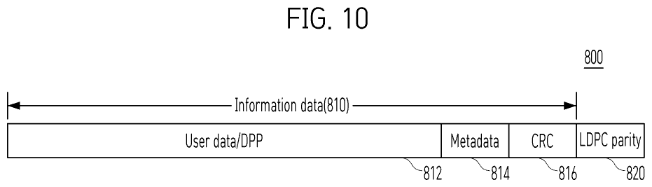

As background, FIG. 10 is a diagram illustrating a format of a codeword 800 to be stored in a storage system. Referring to FIG. 10, the codeword 800 may include information data 810 (information bits or user data) and LDPC parity data 820. In some embodiments, the codeword 800 may be generated by the LDPC codes noted above.

The information data 810 may include user data with data path protection (DPP) 812, meta-data 814 and cyclic redundancy check (CRC) parity bits 816. A CRC code which is an error-detecting code commonly used in digital networks and storage devices may detect accidental changes to raw data.

In a typical LDPC decoder, if the LDPC checksum is zero, the decoding may be terminated. The CRC parity bits 816 will be computed based on the decoded user data 812 and meta-data 814 after the LDPC decoding. If the computed CRC parity bits match the decoded CRC parity bits, decoding may be successful. Otherwise, a mis-correction may be declared.

As described above with reference to FIG. 10, when a read command is received from a host, a memory system (e.g., an SSD) uses a sequence of read retry entries to read and decode data of memory cells. Each read retry entry includes a different read bias. Vt optimization to find an optimal center read bias, and soft read and decoding using the optimal center read bias may also be performed when all hard read retry operations failed. Using additional reads or failed hard reads to adjust read retry entries can degrade a quality of service (QoS) of the memory system. Accordingly, embodiments of the present disclosure provide a proactive dynamic read retry scheme to proactively manage read retry entries for hard reads. The proactive dynamic read retry scheme uses a set of different read biases for a first read (hard read), which does not need additional reads. Thus, the read retry scheme can improve QoS of the memory system across different NAND conditions, even when conditions are changing constantly.

Referring back to FIG. 9, the controller 100 of the memory system 10, i.e., the read processor 710 may perform a sequence of hard reads (HRs) to read data stored in the memory cells 210 of the memory device 200. As illustrated in FIG. 8, N hard reads may be performed. For example, 5 hard reads (HRs) may be used (S100) before soft read is triggered (S300). The read biases (read retry entries) used in 5 hard reads may be defined as R0, R1, R2, R3 and R4. The number of hard read retry entries may be arbitrary.

### Nand Operations

In an SSD, the fail bit count (FBC) of a hard page read is usually asymmetric, i.e., the number of 1 to 0 errors is not equal to the number of 0 to 1 errors. The asymmetry ratio AR is defined as: AR=(# of 1 to 0 errors)/(# of 0 to 1 errors). AR=1 means that the errors are symmetric. Very likely, a page read has a high asymmetry ratio. In some cases, even if a page read has quite symmetric errors, i.e., AR is around 1, each read threshold of a page read (e.g., R3 and R7 of an LSB read) may have quite asymmetric errors. NAND asymmetric errors are common since NAND VT distributions and read thresholds vary with the longevity of the SSD run time. As a result, the initial fixed log-likelihood ratio (LLR) of a Min-Sum Hard (MSH) decoder may no longer optimal. However, as the present invention recognizes, the asymmetry ratio information of each read threshold can be utilized to adjust the LLR of MSH decoder to improve the correction capability, thus enhancing the success rate of a first read as well as the associated SSD QoS.

In one embodiment of the present invention, NAND assist reads are used to distinguish each read threshold associated with a page read. In one embodiment of the present invention, a machine learning based algorithm is used to learn the asymmetry information of each read threshold and to adjust the LLR of the decoder accordingly during the decoding. The LLR update frequency can be controlled by a machine parameter programmed into a memory controller (for example programmed into memory controller 100 or control circuit 220 of FIG. 2 or decoder 720 of FIG. 9), which can be updated at every iteration (or every few iterations e.g., 2 to 100 iterations). The LLR is expected to eventually converge to an optimal LLR. Hardware implementation of this machine learning is not complicated as a complex Log function (used in the programmed algorithm) can be realized by a look up table assessable to control circuit 220 of FIG. 2 or decoder 720 of FIG. 9. This novel processing algorithm can bring significant gain in terms of correction capability and decoding latency.

### LDPC Checksum

For an LDPC code with mxn parity-check matrix H, the check sum (CS) computation of a length-n noisy codeword r (e.g., codeword 800 of FIG. 10) can be expressed as follows: 1) SYND=rH^{T}; 2) CS is the number of 1's in the vector SYND.

### TLC NAND Page Read and Assist Read

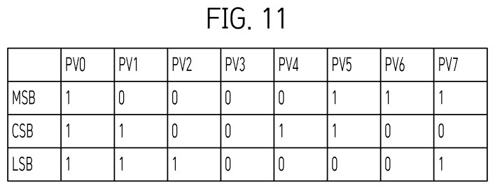

Considering a TLC NAND as an example. A TLC NAND has 8 states PV0, PV1, . . . , PV7. A TLC NAND has 3 page types LSB, CSB, and MSB. An example of Gray labelling of TLC NAND is shown in FIG. 11.

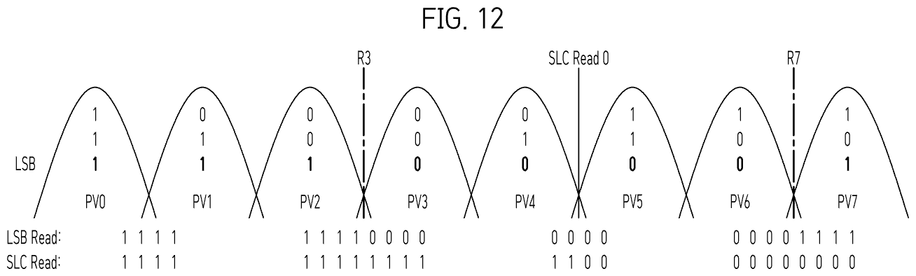

LSB page read thresholds are R3 and R7 as shown in FIG. 12. For LSB read shown at the bottom of FIG. 12, if the cell voltage is lower than R3 or larger than R7, the read data is 1. If the cell voltage is between R3 and R7, the read data is 0. For SLC read shown at the bottom of FIG. 12, if the cell voltage is lower than SLC Read 0, the read data is 1; otherwise, it is 0.

FIG. 12 also shows 1 NAND assist read at a SLC read bias (SLC Read 0) between the different read biases R3 and R7 (in this case at a mid-point between R3 and R7). The NAND assist read reads the TLC at the SLC read bias shown in FIG. 12. The SLC read bias can be adjusted. In this example, it is at the middle point between R3 and R7. The pattern of a cell may be determined according to 2 bits, one bit from the LSB page read and one bit from the NAND assist read at the SLC bias. As shown in Table 1, for a cell with a LSB page read of 1 and SLC assist read of 1, the cell pattern is 0.

TABLE 1
Pattern of a cell by LSB read and one SLC read

| Pattern | 0 | 1 | 2 | 3 |
|---|---|---|---|---|
| LSB | 1 | 0 | 0 | 1 |
| SLC | 1 | 1 | 0 | 0 |

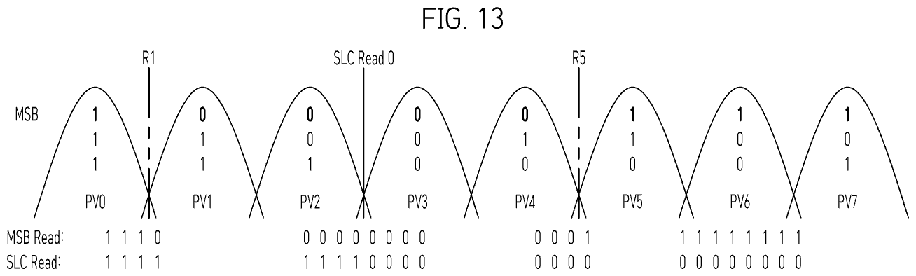

MSB page is similar to LSB page. MSB page read thresholds are R1 and R5 as shown in FIG. 13. FIG. 13 also shows 1 NAND assist read at a SLC read bias (SLC Read 0) between the different read biases R1 and R5 (in this case at a mid-point between R1 and R5). The pattern of a cell is determined according to 2 bits, one bit from the MSB page read and one bit from the NAND assist read at the SLC bias. As shown in Table 2, for a cell with a MSB page read of 1 and a SLC assist read of 0, the cell pattern is 3.

TABLE 2
Pattern of a cell by MSB read and one SLC read

| Pattern | 0 | 1 | 2 | 3 |
|---|---|---|---|---|
| MSB | 1 | 0 | 0 | 1 |
| SLC | 1 | 1 | 0 | 0 |

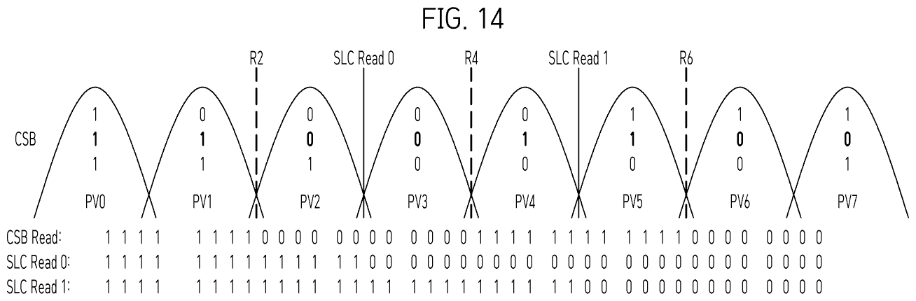

CSB page read thresholds are R2, R4, and R6 as shown in FIG. 14. FIG. 14 also shows 2 NAND assist reads at two SLC read biases (SLC Read 0 and SLC Read 1), with SLC Read 0 between the read biases R2 and R4 and with SLC Read 1 between the read biases R4 and R6 (in this case SLC Read 0 and SLC Read 1 respectively at the mid-points). The pattern of a cell is determined according to the 3 bits, one bit from the CSB page read and two bits from the 2 NAND assist reads at the SLC biases SLC. As shown in Table 3, for a cell with a CSB page read of 1, two SLC reads of 0 and 0, the cell pattern is 4.

TABLE 3
Pattern of a cell by CSB read and two SLC reads

| Pattern | 0 | 1 | 2 | 3 | 4 | 5 |
|---|---|---|---|---|---|---|
| CSB | 1 | 0 | 0 | 1 | 1 | 0 |
| SLC0 | 1 | 1 | 0 | 0 | 0 | 0 |
| SLC1 | 1 | 1 | 1 | 1 | 0 | 0 |

### Cell Pattern and LLR

In general, as detailed above, a pattern can be generated for each cell according to page read and assist read results. Consider an example have a total of K patterns, denoted by 0, 1, 2, . . . , K−1. The so-called log-likelihood ratio (LLR) of each pattern i is defined as:

$$LLR ( i ) = log ( \frac{p ( x = 0 / y = i )}{p ( x = 1 / y = i )} ) = log ( \frac{p ( x = 0 / y = i )}{p ( x = 1 / y = i )} ) ,$$

where i=0, 1, 2, . . . , K−1, x is the sent binary data and y is the pattern data read. For TLC LSB or MSB with one assist read, K=4, as shown in Table 1 and Table 2. For TLC CSB with two assist reads, K=6, as shown in Table 3. In ideal case, there would be a fixed probability for each of the K patterns. However, as the NAND degrades over time, the distribution of the K patterns changes. By adjusting the LLR based on the changing (and measured) distribution, there is a higher chance of successfully decoding the read data from the multi-level cells.
Machine Learning Based MSH Decoder with NAND Assist Reads

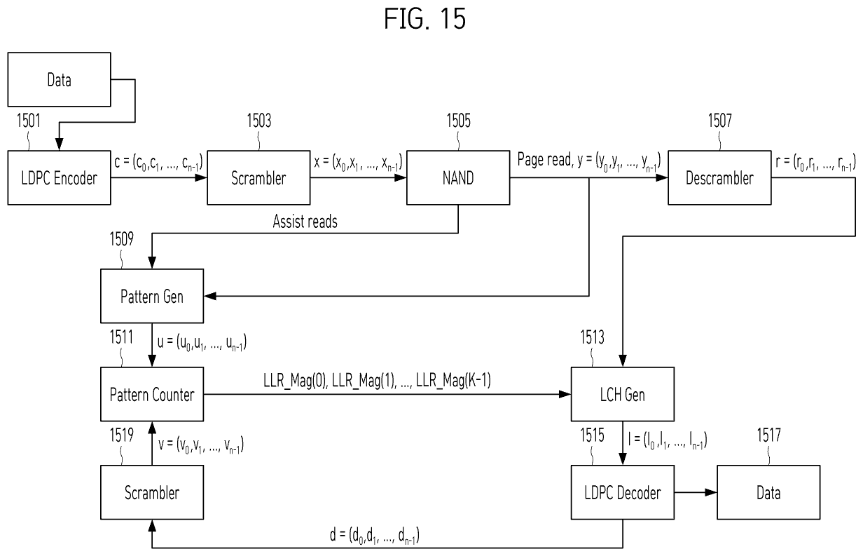

FIG. 15 represents, according to one embodiment, the architecture of machine learning based MSH decoder with NAND assist reads. The data is encoded by an LDPC encoder 1501 to generate a codeword c=(c₀, c₁, . . . , cₙ₋₁). The scrambler 1503 generates a binary sequence x=(x₀, x₁, . . . , xₙ₋₁). Here x=bitwise_xor (c, s), where s=(s₀, s₁, . . . , sₙ₋₁) is a binary scrambling sequence, and bitwise_xor (c, s) represents an exclusive OR (xor) operation between the codeword c and the sequence S.

The inventive LDPC decoding works as follows:

Step 1. Read at the read processor 710 of FIG. 9 data from NAND 1505 using page read to obtain a binary sequence y=(y₀, y₁, . . . , yₙ₋₁).

Step 2. Read at the read processor 710 data from NAND 1505 using assist reads. As shown in FIGS. 12, 13, for TLC LSB or MSB, use 1 assist read. As shown in FIG. 14, for TLC CSB, use 2 assist reads.

Step 3. Generate at descrambler 1507 a descrambled sequence r=(r₀, r₁, . . . , rₙ₋₁), where r=bitwise_xor(y, s).

Step 4. Generate at pattern generator 1509 a sequence of patterns u=(u₀, u₁, . . . , uₙ₋₁), where u_i={0, 1, . . . , K−1}, using y and the bits from assist reads according to a pattern table. For TLC LSB and MSB, K=4, the pattern tables are Table 1 and Table 2 respectively. For TLC CSB, K=6, the pattern table is Table 3.

Step 5. Initialize at LCH generator 1513 LLR0=4 and LLR1=−4. (Other values instead of 4 and −4 can be initially used.)

Step 6. (According to conventional communication theory terminology, the NAND read process can be modelled as a noisy communication channel.) Generate at LCH (the LLR value for Channel) generator 1513 an LCH sequence I=(I₀, I₁, . . . , Iₙ₋₁) by applying LLR0 and LLR1 to r as follows:

```
FOR i = 0 : n − 1
  IF rᵢ==0: lᵢ = LLR0
  ELSE: lᵢ = LLR1
  END
END
```

Step 7. FOR a decoding iteration (iter)=0: ITER_Max:
a. Conduct Min-Sum hard decoding with LCH sequence (I₀, I₁, . . . , Iₙ₋₁) to generate at LDPC decoder 1515 a decoded binary sequence d=(d₀, d₁, . . . , dₙ₋₁).
b. Calculate checksum CS using the decoded sequence d.
c. IF CS==0 or iter==ITER_Max:
   Terminate decoding and output data (i.e., the decoded sequence) at 1517
END
d. IF CS<a predetermined threshold α && iter>a predetermined threshold β && iter % γ==0:
1) Generate at scrambler 1519 a binary sequence v=(v₀, v₁, . . . , vₙ₋₁) based on the decoded data (sequence) d=(d₀, d₁, . . . , dₙ₋₁) from LDPC decoder 1515, where v=bitwise_xor (d, s).
2) Calculate at pattern counter 1511 the number of each of the K patterns. Specifically, calculate the numbers of PC(0, 0), PC(1, 0), PC(0, 1), PC(1, 1), . . . , PC(0, K−1), and PC(1, K−1) where PC(0, j) is the number of positions in sequences v and u such that v_i=0 and u_i=j, i=0, 1, . . . , . . . , n−1, j=0, 1, . . . , . . . , K−1, and PC(1, j) is the number of positions in sequences v and u such that v_i=1 and u_i=j, i=0, 1, . . . , . . . , n−1, j=0, 1, . . . , . . . , K−1.
3) Compute at pattern counter 1511

$$LLR\_Mag ( j ) = \vert Round ( Log ( \frac{PC ( 0 , j )}{PC ( 1 , j )} ) ) \vert j = 0 , 1 , … , … , K - 1 ,$$

generated based on the number distribution of patterns.

| FOR i = 0, 2, 4, ... , K − 2: | |
|---|---|
| IF iter > φ && iter < Ψ && \| LLR_Mag(i) − | |
| LLR_Mag(i + 1) \| < θ: | |
| ∘ | LLR_Mag(i) = 4 (other values instead of 4 |
| | can be used) |
| ∘ | LLR_Mag(i + 1) = 4 (other values instead |
| | of 4 can be used) |

```
    END
  END
```

4) Update at LLR Generator 1513 the LCH sequence I=(I₀, I₁, . . . , Iₙ₋₁) according to LLR_Mag(0), LLR_Mag(1), . . . , LLR_Mag(K−1), sequence r, and sequence u as follows:

```
FOR i=0:n−1
  IF rᵢ= =0: lᵢ = LLR_Mag(u_i)
  ELSE: lᵢ = −LLR_Mag(u_i)
  END
END
```

The control parameters (noted above) α, β, γ, φ, ψ, and θ in Step 7 can be optimized offline for example by injecting a certain number of errors, say 300 errors, run simulations can be used to test the decoding failure rates for N settings of these control parameters, say N=20, and the setting that has the smallest decoding failure rate can be chosen as the optimized value.

In Step 7. d. 3), the calculation of

$$LLR\_Mag ( j ) = \vert Round ( Log ( \frac{PC ( 0 , j )}{PC ( 1 , j )} ) ) \vert$$

For TLC LSB and MSB, K=4

LLR_Mag(0)=Round(Log(PC(1,0))−Log(PC(0,0)))

LLR_Mag(1)=Round(Log(PC(0,1))−Log(PC(1,1)))

LLR_Mag(2)=Round(Log(PC(0,2))−Log(PC(1,2)))

LLR_Mag(3)=Round(Log(PC(1,3))−Log(PC(0,3)))

For TLC CSB, K=6

LLR_Mag(0)=Round(Log(PC(1,0))−Log(PC(0,0)))

LLR_Mag(1)=Round(Log(PC(0,1))−Log(PC(1,1)))

LLR_Mag(2)=Round(Log(PC(0,2))−Log(PC(1,2)))

LLR_Mag(3)=Round(Log(PC(1,3))−Log(PC(0,3)))

LLR_Mag(4)=Round(Log(PC(1,4))−Log(PC(0,4)))

LLR_Mag(5)=Round(Log(PC(0,5))−Log(PC(1,5)))

For hardware implementation, the Log function y=Log(x) can be realized by using a look up table:

```
    if (x < 2){
    y = 0;
    } else if (x < 4) {
  y = 1;
  } else if (x < 12) {
      y = 2;
    } else if (x < 33) {
    y = 3;
} else if (x < 90) {
  y = 4;
  } else if (x < 245) {
  y = 5;
} else if (x < 665) {
y = 6;
  } else if (x < 1808) {
  y = 7;
} else if (x < 4915) {
  y = 8;
} else if (x < 13360) {
y = 9;
} else {
y = 10;
  }
```

In this disclosure, NAND assist reads are used to distinguish each read threshold of a page read. For example, in LSB read, if the read bit is 1, one does not know if this bit is 1 due to the cell voltage being below R3 or above R7. However, with an assist SLC read bit, one can distinguish which case is true. If the assist SLC read bit is 1, the cell voltage is below R3; if the assist SLC read bit is 0, the cell voltage is above R7. The pattern of each cell is generated according to results of a page read and a NAND assist read. The condition to update LLR is given in terms of checksum and iteration number. Scrambling and descrambling operations can be used. The pattern counters are computed to adjust LLR. The hardware implementation of Log function can be realized by using a look up table.

### Computerized Method

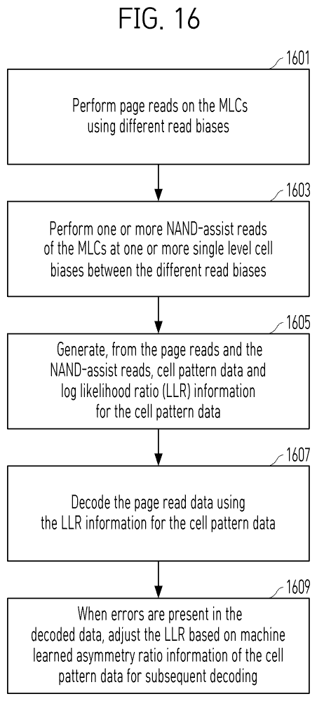

FIG. 16 is a flowchart illustrating a method for operating a memory system. The method may be performed by a memory system (e.g., the memory system 10 of FIG. 1), which includes a controller (e.g., the memory controller 100 of FIGS. 1 and 9) and a memory device (e.g., the semiconductor memory device 200 of FIGS. 1 and 9) including one or more pages (cells) for storing data. The method performed by the controller may be implemented with firmware (FW), e.g., the firmware of the control component 120 of the controller 100 in FIG. 2, or the read processor 710 and the decoder 720 of the controller 100 in FIG. 9.

Referring to FIG. 16, the method at 1601 includes performing page reads on the MLCs using different read biases. The method at 1603 includes performing one or more NAND-assist reads of the MLCs at one or more single level cell biases between the different read biases. The method at 1605 includes generating, from the page reads and the NAND-assist reads, cell pattern data and log likelihood ratio (LLR) information for the cell pattern data. The method includes at 1607 decoding the page read data using the LLR information for the cell pattern data. The method at 1609 includes, when errors are present in the decoded data, adjusting the LLR based on machine learned asymmetry ratio information of the cell pattern data for subsequent decoding.

In some embodiments, wherein the decoding comprises min-sum hard decoding the page read data to generate a decoded binary sequence; and calculating a checksum for the decoded binary sequence to determine adjustment of the LLR.

In some embodiments, the method further includes updating the LLR until min-sum hard decoding realizes a checksum of zero.

In some embodiments, the method further includes scrambling the decoded data, wherein the NAND device stores data encoded using a low density parity check (LDPC) code, and the min-sum decoded data is decoded using the LDPC code.

In some embodiments, the method includes: receiving and encoding data stored in the memory device; scrambling the encoded data for storage in the NAND device; receiving and descrambling data read from pages of the NAND device by the controller; decoding the descrambled data and detecting errors in the descrambled data; generating the cell pattern data by merging page data read and NAND assist data read; calculating the asymmetry ratio information based on the cell patterns; and based on the asymmetry ratio information, adjusting the LLRs for the subsequent decoding.

In some embodiments, the method includes reading data from the NAND device using one or more page reads to obtain a binary sequence y=(y₀, y₁, . . . , yₙ₋₁); reading data from NAND device using assist reads at SLCs; generating a descrambled sequence r=(r₀, r₁, . . . , rₙ₋₁), where r=bitwise_xor(y, s), where s=(s₀, s₁, . . . , sₙ₋₁) is a binary scrambling sequence; generating for the cell pattern data a sequence of cell patterns u=(u₀, u₁, . . . , uₙ₋₁), where ui∈{0, 1, . . . , K−1}, using the binary sequence y and bits from the assist reads; initializing values of LLR; applying the values of LLR to the descrambled sequence r to thereby min-sum decode the descrambled sequence r; after application of the values of LLR, decoding the descrambled sequence to produce decoded data d=(d₀, d₁, . . . , dₙ₋₁), and checking for errors in the decoded data d with a LDPC decoder calculating a checksum.

In some embodiments, the method further includes generating a binary sequence v=(v₀, v₁, . . . , vₙ₋₁) based on the decoded data d=(d₀, d₁, . . . , dₙ₋₁), where v=bitwise_xor (d, s); and counting respective numbers of the cell patterns in the binary sequence v to ascertain the asymmetry ratio information.

In some embodiments, the method further includes calculating, for the information related to the asymmetry ratio, respective numbers of PC(0, 0), PC(1, 0), PC(0, 1), PC(1, 1), . . . , PC(0, K−1), and PC(1, K−1) where PC(0, j) is the number of positions in sequences v and u such that v_i=0 and u_i=j, i=0, 1, . . . , n−1, j=0, 1, . . . , . . . , K−1, and PC(1, j) is the number of positions in sequences v and u such that v_i=1 and u_i=j, i=0, 1, . . . , . . . , n−1, j=0, 1, . . . , . . . , K−1.

In some embodiments, the method further includes computing, for the adjusted LLR,

$$LLR\_Mag ( j ) = \vert Round ( Log ( \frac{PC ( 0 , j )}{PC ( 1 , j )} ) ) \vert ,$$

where j=0, 1, . . . , . . . , K−1.

In some embodiments, the method further includes comprising using a look-up table for calculation of

$$\vert Round ( Log ( \frac{PC ( 0 , j )}{PC ( 1 , j )} ) ) \vert ,$$

where j=0, 1, . . . , K−1.

### Memory System Configuration

A memory system (e.g., memory system 10 of FIG. 1) according to embodiments of the present disclosure comprises a NAND device (e.g., semiconductor memory device 200 of FIGS. 1 and 9) having single level cells and multi-level memory cells (e.g., memory cells 210 of FIGS. 1 and 9) for storing data; a controller (e.g., the memory controller 100 of FIGS. 1 and 9) coupled to the NAND device. The controller is configured to: perform page reads on the MLCs using different read biases; performing one or more NAND-assist reads of the MLCs at one or more single level cell biases between the different read biases; generate, from the page reads and the NAND-assist reads, cell pattern data and log likelihood ratio (LLR) information for the cell pattern data; decode the page read data using the LLR information for the cell pattern data; and when errors are present in the decoded data, adjust the LLR based on machine learned asymmetry ratio information of the cell pattern data for subsequent decoding.

In some embodiments, the controller is configured to min-sum hard decode the page read data to generate a decoded binary sequence; and calculate a checksum for the decoded binary sequence to determine adjustment of the LLR.

In some embodiments, the controller is configured to update the LLR until min-sum hard decoding realizes a checksum of zero.

In some embodiment, the memory system further includes an error correction circuit (e.g., the ECC Component 130 of FIG. 2) coupled to the controller, wherein the error correction circuit is configured for low density parity check (LDPC) encoding and decoding and is configured to error check the min-sum decoded data.

In some embodiments, the memory system further includes an LDPC encoder configured to receive and encode data stored in the memory device; a scrambler configured to receive and scramble the encoded data for storage in the NAND device; a descrambler configured to receive and descramble data read from pages of the NAND device by the controller; an LDPC decoder configured to decode the descrambled data and detect errors in the descrambled data; a pattern generator configured to generate the cell pattern data by merging page data read and NAND assist data read; and a pattern counter configured to: calculate the asymmetry ratio information on the cell patterns; and based on the asymmetry ratio information, adjust the LLRs for the subsequent decoding.

In some embodiments, the controller is configured to control the following operations: read data from the NAND device using one or more page reads to obtain a binary sequence y=(y₀, y₁, . . . , yₙ₋₁); read data from NAND device using assist reads at SLCs; generate a descrambled sequence r=(r₀, r₁, . . . , rₙ₋₁), where r=bitwise_xor(y, s), where s=(s₀, s₁, . . . , sₙ₋₁) is a binary scrambling sequence; generate for the cell pattern data a sequence of cell patterns u=(u₀, u₁, . . . , uₙ₋₁), where ui∈{0, 1, . . . , K−1}, using the binary sequence y and bits from the assist reads; initialize values of LLR; apply the values of LLR to the descrambled sequence r to thereby min-sum decode the descrambled sequence r; after application of the values of LLR, decode the descrambled sequence to produce decoded data d=(d₀, d₁, . . . , dₙ₋₁), and check for errors in the decoded data d with a LDPC decoder calculating a checksum.

In some embodiments, the controller is further configured to generate a binary sequence v=(v₀, v₁, . . . , vₙ₋₁) based on the decoded data d=(d₀, d₁, . . . , dₙ₋₁), where v=bitwise_xor (d, s); and count respective numbers of the cell patterns in the binary sequence v to ascertain information related to the asymmetry ratio information.

In some embodiments, the controller is further configured to: calculate, for the information related to the asymmetry ratio information, respective numbers of PC(0, 0), PC(1, 0), PC(0, 1), PC(1, 1), . . . , PC(0, K-1), and PC(1, K−1) where PC(0, j) is the number of positions in sequences v and u such that v_i=0 and u_i=j, i=0, 1, . . . , . . . , n−1, j=0, 1, . . . , . . . , K−1, and PC(1, j) is the number of positions in sequences v and u such that v_i=1 and u_i=j, i=0, 1, . . . , . . . , n−1, j=0, 1, . . . , . . . , K−1.

In some embodiments, the controller is further configured to compute, for the adjusted LLR,

$$LLR\_Mag ( j ) = \vert Round ( Log ( \frac{PC ( 0 , j )}{PC ( 1 , j )} ) ) \vert ,$$

where j=0, 1, . . . , . . . , K−1.

In some embodiments, the controller is configured is programmed with a look-up table for calculation of

$$\vert Round ( Log ( \frac{PC ( 0 , j )}{PC ( 1 , j )} ) ) \vert ,$$

where j=0, 1, . . . , . . . , K−1.

Although the foregoing embodiments have been described in some detail for purposes of clarity of understanding, the invention is not limited to the details provided. There are many alternative ways of implementing the invention. The disclosed embodiments are illustrative and not restrictive. The present invention is intended to embrace all modifications and alternatives of the disclosed embodiments. Furthermore, the disclosed embodiments may be combined to form additional embodiments.

Indeed, implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A memory system comprising:
a NAND device having multi-level cells (MLCs) with pages of data stored therein; and
a controller coupled to the NAND device, and configured to:
perform page reads on the MLCs using different read biases;
perform one or more NAND-assist reads of the MLCs at one or more single level cell biases between the different read biases;
generate, from the page reads and the NAND-assist reads, cell pattern data and log likelihood ratio (LLR) information for the cell pattern data;
decode the page read data using the LLR information for the cell pattern data; and
when errors are present in the decoded data, adjust the LLR based on machine learned asymmetry ratio information of the cell pattern data for subsequent decoding.

2. The memory system of claim 1, wherein the controller is configured to:
min-sum hard decode the page read data to generate a decoded binary sequence; and
calculate a checksum for the decoded binary sequence to determine adjustment of the LLR.

3. The memory system of claim 2, wherein the controller is configured to update the LLR until min-sum hard decoding realizes a checksum of zero.

4. The memory system of claim 2, wherein the controller includes an error correction circuit configured for low density parity check (LDPC) encoding and decoding and configured to error check the min-sum decoded data.

5. The memory system of claim 4, wherein the controller includes:
an LDPC encoder configured to receive and encode data stored in the NAND device;
a scrambler configured to receive and scramble the encoded data for storage in the NAND device;
a descrambler configured to receive and descramble data read from pages of the NAND device;
an LDPC decoder configured to decode the descrambled data and detect errors in the descrambled data;
a pattern generator configured to generate the cell pattern data by merging page data read and NAND assist data read; and
a pattern counter configured to:
calculate the asymmetry ratio information on the cell patterns; and
based on the asymmetry ratio information, adjust the LLRs for the subsequent decoding.

6. The memory system of claim 1, wherein the controller is configured to control the following operations:
read data from the NAND device using one or more page reads to obtain a binary sequence y=(y₀, y₁, . . . , yₙ₋₁);
read data from NAND device using assist reads at SLCs; generate a descrambled sequence r=(r₀, r₁, . . . , rₙ₋₁), where r=bitwise_xor(y, s), where S=(s₀, s₁, . . . , sₙ₋₁) is a binary scrambling sequence;
generate for the cell pattern data a sequence of cell patterns u=(u₀, u₁, . . . , uₙ₋₁), where uᵢ∈{0, 1, . . . , K−1}, using the binary sequence y and bits from the assist reads;
initialize values of LLR;
apply the values of LLR to the descrambled sequence r to thereby min-sum decode the descrambled sequence r;
after application of the values of LLR, decode the descrambled sequence to produce decoded data d=(d₀, d₁, . . . , dₙ₋₁); and
check for errors in the decoded data d with a LDPC decoder calculating a checksum.

7. The memory system of claim 6, wherein the controller is further configured to
generate a binary sequence v=(v₀, v₁, . . . , vₙ₋₁) based on the decoded data d=(d₀, d₁, . . . , dₙ₋₁), where v=bitwise_xor (d, s); and
count respective numbers of the cell patterns in the binary sequence v to ascertain information related to the asymmetry ratio information.

8. The memory system of claim 7, wherein the controller is further configured to:
calculate, for the information related to the asymmetry ratio information, respective numbers of PC(0, 0), PC(1, 0), PC(0, 1), PC(1, 1), PC(0, K−1), and PC(1, K−1) where
PC(0, j) is the number of positions in sequences v and u such that v_i=0 and u_i=j, i=0, 1, . . . , . . . , n−1, j=0, 1, . . . , . . . , K−1, and
PC(1, j) is the number of positions in sequences v and u such that v_i=1 and u_i=j, i=0, 1, . . . , . . . , n−1, j=0, 1, . . . , . . . , K−1.

9. The memory system of claim 7, wherein the controller is further configured to compute, for the adjusted LLR,
$$LLR\_Mag ( j ) = \vert Round ( Log ( \frac{PC ( 0 , j )}{PC ( 1 , j )} ) ) \vert ,$$
where j=0, 1, . . . , . . . , K−1.

10. The memory system of claim 9, wherein the controller is programmed with a look-up table for calculation of
$$\vert Round ( Log ( \frac{PC ( 0 , j )}{PC ( 1 , j )} ) ) \vert ,$$
where j=0, 1, . . . , . . . , K−1.

11. A method for operating a memory system including a NAND device having multi-level cells (MLCs) with pages of data stored therein, the method comprising:
performing page reads on the MLCs using different read biases;
performing one or more NAND-assist reads of the MLCs at one or more single level cell biases between the different read biases;
generating, from the page reads and the NAND-assist reads, cell pattern data and log likelihood ratio (LLR) information for the cell pattern data;
decoding the page read data using the LLR information for the cell pattern data; and
when errors are present in the decoded data, adjusting the LLR based on machine learned asymmetry ratio information of the cell pattern data for subsequent decoding.

12. The method of claim 11, wherein the decoding comprises
min-sum hard decoding the page read data to generate a decoded binary sequence; and
calculating a checksum using the decoded binary sequence.

13. The method of claim 12, further comprising updating the LLR until min-sum hard decoding realizes a checksum of zero.

14. The method of claim 12, further comprising scrambling the decoded data, wherein the NAND device stores data encoded using a low density parity check (LDPC) code, and the min-sum decoded data is decoded using the LDPC code.

15. The method of claim 11, further comprising:
receiving and encoding data for storage in the NAND device;
scrambling the encoded data and storing the scrambled data in the NAND device;
receiving and descrambling data read from pages of the NAND device;
decoding the descrambled data and detecting errors in the descrambled data;
generating the cell pattern data by merging page data read and NAND assist data read;
calculating the asymmetry ratio information based on the cell patterns; and
based on the asymmetry ratio information, adjusting the LLRs for the subsequent decoding.

16. The method of claim 11, further comprising:
reading data from the NAND device using one or more page reads to obtain a binary sequence y=(y₀, y₁, . . . , yₙ₋₁);
reading data from NAND device using assist reads at SLCs;
generating a descrambled sequence r=(r₀, r₁, . . . , rₙ₋₁), where r=bitwise_xor(y, s), where s=(s₀, s₁, . . . , sₙ₋₁) is a binary scrambling sequence;
generating for the cell pattern data a sequence of cell patterns u=(u₀, u₁, . . . , uₙ₋₁), where uᵢ∈{0, 1, . . . , K−1}, using the binary sequence y and bits from the assist reads;
initializing values of LLR;
applying the values of LLR to the descrambled sequence r to thereby min-sum decode the descrambled sequence r;
after application of the values of LLR, min-sum decoding the descrambled sequence to produce decoded data d=(d₀, d₁, . . . , dₙ₋₁), and
checking for errors in the decoded data d with a LDPC decoder calculating a checksum.

17. The method of claim 16, further comprising:
generating a binary sequence v=(v₀, v₁, . . . , vₙ₋₁) based on the decoded data d=(d₀, d₁, . . . , dₙ₋₁), where v=bitwise_xor (d, s); and
counting respective numbers of the cell patterns in the binary sequence v to ascertain information related to the asymmetry ratio information.

18. The method of claim 17, further comprising:
calculating, for the information related to the asymmetry ratio, respective numbers of PC(0, 0), PC(1, 0), PC(0, 1), PC(1, 1), . . . , PC(0, K−1), and PC(1, K−1) where
PC(0, j) is the number of positions in sequences v and u such that v_i=0 and u_i=j, i=0, 1, . . . , . . . , n−1, j=0, 1, . . . , . . . , K−1, and
PC(1, j) is the number of positions in sequences v and u such that v_i=1 and u_i=j, i=0, 1, . . . , . . . , n−1, j=0, 1, . . . , . . . , K−1.

19. The method of claim 17, further comprising: computing, for the adjusted LLR,
$$LLR\_Mag ( j ) = \vert Round ( Log ( \frac{PC ( 0 , j )}{PC ( 1 , j )} ) ) \vert ,$$
where j=0, 1, . . . , . . . , K−1.

20. The method of claim 19, further comprising using a look-up table for calculation of
$$\vert Round ( Log ( \frac{PC ( 0 , j )}{PC ( 1 , j )} ) ) \vert ,$$
where j=0, 1, . . . , . . . , K−1.
